(19) United States
(12) Patent Application Publication
(10) Pub. No.: US 2023/0316294 A1
(43) Pub. Date: Oct. 5, 2023

(54) AUTOMOTIVE WARRANTY AND FINANCING METHOD

(71) Applicant: John M Giuffre, Hilo, HI (US)

(72) Inventor: John M Giuffre, Hilo, HI (US)

(21) Appl. No.: 18/077,020

(22) Filed: Dec. 7, 2022

Related U.S. Application Data
(60) Provisional application No. 63/316,240, filed on Mar. 3, 2022.

(51) Int. Cl. G06Q 30/00

(52) U.S. Cl. CPC G06Q 30/012

(57) ABSTRACT

A method for providing automotive warranties and financing is disclosed, including the steps of consolidating the used car industry by performing the following: replacing the third-party players, reducing the cost of parts and labor, managing insurance providers, and controlling pricing and labor. Next, warranties and co-pays are provided. The cost is segregated over a period of time, such as a thirty year financing term. Finally, a membership program is provided.

### CROSS-REFERENCE TO RELATED APPLICATIONS

This application claims priority to U.S. Provisional Application No. 63/316,240 filed Mar. 3, 2022, titled “AUTOMOTIVE WARRANTY AND FINANCING METHOD,” which is hereby incorporated by reference in its entirety.

### TECHNICAL FIELD

The embodiments generally relate to methods for automotive warranties and financing.

### BACKGROUND

Often, rather than purchasing a vehicle outright, consumers select to finance the vehicle. This allows the consumer to borrow the money and pay off their vehicle in installments. A warranty may also be included as a component of the sale. In the United States, new car factory warranties often range from one year to five years and in some cases extend to ten years, there are few that even extend to a million-miles. These warranties typically include a mileage limit and may be extended by the manufacturer or other company with a renewal fee but few extend over a couple hundred thousand. Used car warranties often provide less coverage such as three months and 3,000 miles.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate to a method for providing automotive warranties and financing, including the steps of consolidating the used car industry by performing the following: replacing the third-party players, reducing the cost of parts and labor, managing insurance providers, and controlling pricing and labor. Next, warranties and co-pays are provided. The cost is segregated over a period of time, such as a thirty year financing term. Lastly, a membership program is provided.

The method provided herein includes a membership, warranty, and financing which provides a defined formula that begins and ends with a new financial product with its own (9) 10 (15)-30 year terms. The (9) 10 (15)-30 year terms includes financing, services, and warranty packages.

Herein may demonstrate the simplest demonstrating to a truly original product. The cumulative impact leaves us with an exact opposite trend over those of today’s entire market system wherein money is made from the sale of parts and labor aka repairs, and will now, instead have the revenues generated from the monthly ‘Membership’ fees until otherwise interrupted by the costs for those same repairs. This leaves all the incentives on improved engineering and other significantly up-graded steps to cost efficiencies.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

The industry response to shifting market demands contrasts them to our Dura-Tech (Warranty & Financing) Auto-Membership program aka Dura-Tech (Membership). In large part, the industry is simply carrying-on with more of the same bazaar patchwork of limited, conflicting and misleading warranties, or their standard piecemeal and other convoluted service up-grades (as outlined below). Worse still is that the best features, benefits and quality controls are walled-off from much of the used car market. Some of these programs are an outright disaster.

Market divisions are often segmented into self-defeating functions and purpose. They slice and dice the industry, services and the owners experience, into a dreadful mess of contrived sectors, and often, the terms are at odds or outright sabotage of one another. A simple example is the cost and service differential in warranties between drivetrains and those offered for the rest of the engine parts and that’s before we take either in for service. For example, engine blocks are covered, but not the pistons other parts. Some cover moving parts as well, but none cover the exterior body. So many parts to a car, so many different warranty terms and then the oft nightmare scenarios to actually have these service contracts fulfilled.

A few car dealerships even offer a Million-Mile Warranty, but with 3 notable shortfalls.

In the case of some dealerships, they only cover the original buyer as an enticement to have that customer return to ‘upsell’ them into buying a replacement car, but the warranty does not carry over for anyone purchasing from that original owner. These programs miss all the cost savings of the Used Car market otherwise captured with (and intended) by the Dura-Tech Auto Membership program. The system program is specifically tailored to harness the savings through a Process of Consolidation of the entire used car market as a whole - starting right from the very beginning with the manufacturer. This Process towards industry wide upgrade is missed by all the other warranty programs.

Today’s dealership led Million-Mile Warranty fails in this one very serious regard - to reach the large up-grade achieved through improvements initiated from the manufacturing side. We further add to this by following through all the way down the retail chain Process. The Process program must come from the manufacturers side first and foremost and then tailored on through the rest of the distribution, sales, repairs and service areas of the auto industry. The greatest savings are only possible via scaling-up improvements through engineering and then out across all remaining areas of the manufacturing and service venues thereafter.

The third short fall is that none have include the extensive warranty for the Used Car market alongside the savings from a consolidation of financing and insurance as well. Each of these industry divisions have their own areas of upgrades and savings (profits) to be added into the overall package that find their full compounding impact only through their consolidation. This comprehensive overview and Process of Consolidation of industry players, services and steps is otherwise missing from all other warranty programs.

What better example than (the a new pick-up truck from the leading EV maker) that provide all the durability factors as well as consolidation of insurance and financing, and yet, Elon Musk (this EV manufacturer) still has not offered the Million-Mile Warranty and its counter-part with the 30 year financing. You then have those providers offering the million-mile warranty, but without the savings from insurance and financing or the 30-year loan terms that offers buyers savings and affordability or its counter-part in the ‘ Time-Value-of-Money’ for automakers profit margins (as outlined below). And no program includes the body. Only the Cyber Truck (stainless steel body of this leading EV manufacturers body) could afford to offer such a body guarantee. This Dura-Tech Auto Membership program finally ties-inall these areas of consideration and steps of the auto’s entire life span into a seamless Process for a new generation of advantages and benefits with its brand of a SINGLE package that is an entirely original and new service platform - with all its own distinct level of savings and profits unparalleled by all the rest of the industry.

We see the same chaos repeated in the marketing and financing sectors of the industry. They have this array of leasing options vs buying. Each of these serve as one more example of the industry’s struggle to reduce the monthly premiums and down payments in the face of exploding costs and other price constraints. Auto-makers are scrambling with their ever-growing list of financing gimmicks to keep (the appearance of) affordable prices for today’s dwindling middle class - mass market - buyer.

Today’s versions of Auto-membership programs are hardly a little better as they try a variety of terms, and yet, they end up with all the same limitations we see of every other effort (like the 8-year auto loan). In each case, these financing programs fail to effectively reduce costs low enough to offer a significant price reduction over any other typical auto purchase. And at the end of it all, the boogie man still sits in waiting. The minefield of horrific costs of maintaining the car beyond the hard-limit of the industry shelf-life for its half decade warranty.

There are a few high-end ‘luxury’ vehicles with full ‘comprehensive’ services and warranties comparable to the Warranty we present here. However, they fail to match the price affordability we beget of the mass market. No other program brings this level of quality up-grade and extended used car services against the price affordability found with this Dura-Tech Membership (Warranty & Financing) program.

No other program has managed these 5 Steps: 1. Crack the Code of the auto-industries malaise, 2. Translate that into a Formula and then, 3. Give it form with an entirely new commercial Service Platform, 4. Culminating with a series of new services, programs and benefits - each unique in its own right, and 5. Membership Financing is the composite of all these factors for a dramatically different Financial Product not yet seen for the ‘mass market’ until today.

There is one primary secret behind all the savings found, added profits secured and the upgrades offered from this Auto Membership program. It’s mainly taken from the consolidation of the used car market. There is not much room for big improvements in the new car market that is not already being done (mainly by Tesla), but there remain trillions worth of cost efficiencies and profits to be captured in the used car market. This is where the legacy automakers can find the easiest and fastest rewards to their plight of market share struggles.

This maybe best summarized as the marriage of the new and used cars market. They will now stand as one. This partnership uncovers new profit streams to be harnessed throughout production, financing, and marketing efficiencies - as we outline below (mainly for the legacy automakers).

We may be looking at one of the greatest up-grades of the used car experience if not the entirety of the auto-industry. We beget a truly reinvented auto market with a hybrid of programs tailored to serve a host of new options ranging from 10-year to 30-year financing terms, warranties with little to no fine print, big savings for owners and extended incomes that now go into decades for automakers. Compare this against the present 5 to 8 year financing by an otherwise splintered industry of convoluted warranties, terrible service gaps and poor overall quality in care and experience for used car owners.

The Membership maybe best categorized as a service platform. It comes with its own set of services and a specific assessment Formula. It’s quite simple actually. Cover the entire life of the vehicle with a straightforward, comprehensive and single service guarantee.

### Step 1: Replace Third Party Players

The actual step behind this consolidation simply entails replacing third party players like repair shops, dealerships, warranty services, insurance companies and financers that have layered-on a series of unnecessary and too often large fees - Price Gauging - and that’s when we are not dealing with outright fraud that is something of common routine in today’s market. This on top all their cost inefficiencies. The net result is a tipping point wherein automakers can replace these 3^{rd} Party players for a great deal of savings to the (used car) buyer and still have plenty left over to pocket as a handsome profit.

A slew of new market demands and opportunities now press this moral call for large scale reform of the Used Car market. Replace these 3^{rd} Players for failures of service and in so doing, automakers can claw back trillions in new biz for themselves. Yes, trillions as we will outline shortly.

We conclude this step with a rather simple calculus: Let’s say the used car market now has 5 ‘Third Parties’ involved with servicing the average buyer from insurance and dealerships, to Repair shops and finance providers. A 10% savings from each of these players would (in theory) give us a 50% savings. The outline below will show how true this simple formula may prove to be - as already projected by Elon Musk for Tesla. This on top the 3 to 7 fold added income from the 30-year Financing & Warranty Membership program.

### Step 2: Reduce Costs of Parts & Labor 30%

The method starts with a review of a vehicle’s life cycle. From this perch, it’s easier to spot the bottleneck and its costs penalties. We then look to pair the easiest, fastest and most affordable tech and service up-grades, to these common areas of expenses. It’s surprising how big the potential savings and improvements may prove with even the simplest of review of these steps -Process.

Here’s some examples of the ‘simple’ steps of this membership.

Reduce labor costs of repairs by 25% to 70%.

Look for similar savings on auto parts.

Combined, maintenance can be reduced 25% to 50%. That means today’s $80 to $150 an hour mechanic drops to $60 an hour. Same again for parts (in what we gather can run triple their actual costs). Reduce these price inefficiencies and we beget another 25% to 50% savings on parts as well.

We then look to add some rudimentary engineering improvements - on old legacy autos. Automakers should find another 5% to 15% in additional savings. For example, timing belts are said to be engineered to break at 100k miles. That is an easy improvement to upgrade. There are (many) others that can be done with similar ease and minor adjustments. In other words, if automakers now engineer around longevity - durability, they will find easy to implement cost savings here from the design side as well.

### Step 3′Manage’ Insurance Providers = Control Pricing & Labor

The mechanism to all this is the Warranty itself. The industry looks at insurance as a simple assessor that goes around paying out claims. The other side - if not larger role of insurance is overlooked. It so happens that insurance also sets prices, quality standards and winner and losers between providers: who’s in and who’s out.

The membership now takes hold of the used car market by simply serving in this role as abitur of all such services and pricing standards. The warranty is the simple ‘how’ automakers can now manage and run these third parties in the used car market - and replace them when necessary for lack of affordability or quality service.

We see this with Tesla’s insurance program wherein the terms are already beginning to be set directly by Elon Musk (by this leading EV producer) - in just the first couple years of its launch. The Warranty further specialize these cost savings and quality controls now missing from manufacturers control.

This takes us to the third group replaced by this Auto Membership program. That is the auto-insurance companies. Insurance now controls the terms of service, pricing and providers. This is on top their ‘premium’ profits aka cost inefficiencies.

Insurance is the mechanism that best positions automakers to claim and manage the used car market. Here’s where automakers can set their own terms of price and service. Automakers need take over this function if ever they are to effectively manage costs and the quality of care for their autos & customers. Insurance is both the joystick of the entire auto repair industry as well as one of the single largest capital pools of the industry. Elon Musk calculated that his Tesla insurance service would represent as much as 40% of his entire business. Consolidation of insurance services should allow another 20% to 50% worth of savings - depending upon the area of service. In short: Insurance sits center to this Process of Consolidation for it offers industry control over price and quality, great savings alongside its added revenues, profits on top the large pool of capital reserves it offers.

In summary, the 3 Steps of Part 1 of the Formula is to consolidate and manage the used car market while looking to reduce the costs of parts and labor by 25% to 70% alongside some simple engineering upgrades that can be done quickly, easily and affordably. Do this again with insurance. Our example below (Part 3 of the Formula) shows how this all comes together.

### Part 2 of the Formula

### Warranty & Co-Pays

The warranty and co-pay charges are, of course, simply an extension of insurance. We separate them out as a financial patch (play on the term ‘software patch’). The Warranty helps fill the short fall of revenues that cannot be ‘AFFORDABLY’ incorporated into the monthly insurance premiums for today’s owners. These added costs would seem - feel - too expensive if simply included as part of an insurance bill.

In this sense, the Warranty as well as the Co-pay are something of a marketing gimmick. They better clarify the added value the customer is offered through these new policy programs though in actual function, it really is just part of the insurance service.

The warranty premium covers 35% to 50% of the costs of repairs while insurance is covering the rest. In other words, the Warranty and Co-pays are subsidized by the ‘other’ main insurance policy or other such marketing ploys.

The other reason for insurance to pay is that much of those costs are actually a duplicate to what insurance would cover anyway. In other words, let’s say $65 of your $145 a month insurance premium is already designated to repairs. The warranty is just bringing in added revenues to help subsidize insurance and build upon this longer-term warranty. That added revenue is the premium difference needed to cover the extra decades of repairs.

This insurance subsidy is intended to help better package the Warranty’s significant value to the customer. As an example, you pay the Warranty’s small $40 monthly and in turn, you just unlocked $65 worth of insurance benefits as well. In other words, the $40 warranty premium offers to double the value of its premium with these matching funds by the insurance policy - at least by our initial ‘rough estimates.’

The others side of this cost breakdown is that your insurance policy of our membership would not cover such repairs if you forgo the warranty service fee. The (small) price difference of the warranty is just enough to make it worth buying the entire Dura-Tech Membership package. Selling the Dura-Tech Membership in its entirety is ‘really’ what we are actually selling - rather than using the Warranty to sell the car as they do today. We detail this more in the Financing and Membership chapters.

The Dura-Tech (Auto) Membership ties these tech upgrades together alongside all the advantages of these reformulated steps and then, brings them together into a simple package of great service. It’s offered up as a one stop, all-purpose service Platform. From here, we beget all the savings, added revenue and a new set of loans that becomes little more than a natural fit for this longer shelf life of cars outfitted with next generation upgrades. This 30-year financing - marks the final step to both activate and complete this Process we call the Dura-Tech (Auto) Membership program. In other words, we are not offering 30-year financing, but rather, this 30-year financing is the culmination to a series of previous steps that naturally lends itself to this kind of financing options.

The Dura-Tech (Auto) Membership was built from our careful review of (today’s leading EV manufacturer and their) Tesla’s many advantages. We then looked over to legacy automakers to see IF and how this could be translated over into their market.

What today’s legacy auto’s lack in tech improvements (like those we have (with this leading EV manufacturer) Tesla), they make-up in sheer numbers of owners now driving the roads of the world in all their car brands. GM, for example, has about 200 million owners driving their cars. We see similar numbers with all the big legacy manufacturers.

The obvious windfall of this membership program would be to also leverage these hundreds of millions of drivers into the next marketing bonanza for legacy automakers. It does this with a two-step campaign.

First, it converts these drivers into members. This step looks to double if not quadruple legay auto-maker’s corporate revenues.

The second step is to then use this membership platform as a marketing funnel to transition members from their present older cars and slide them into the 2022 high tech vehicles that are better suited to a (half) million-warranty.

More on this second part in a follow up presentation. For now, let’s look at the numbers of these first 3 Steps of our Formula.

### Part 3 of the Formula

### Divvy Up Cost Over Decade(s)

Here’s an example how all these savings and service up-grades come together. Let’s start with our proposed 350,000 warranty for legacy manufactures. The Dura-Tech Membership would extend many if not most of the present 100k warranties into this 350k program - depending upon the vehicle make/brand. Most higher-end pick-up trucks, for example, often appear to already have this durability we beget of quality manufacturing. Dura-Tech Membership would build upon this to formally (and affordably) extend and upgrade these advantages over into this 350k warranty.

Most of today’s autos simply lack the engineering to reach a million-miles, however, many should be able to achieve 30% to 40% that level of durability with ‘AFFORDABLE’ repairs. It may come as a surprise how many owners take pride in their brands 200k to 400k durability. This Dura-Tech campaign taps that good will and durability. Though this may be less revenues then otherwise possible from the top-tiered, 30-year, million-mile warranty; these old legacy automakers can make up for it with their hundreds of millions of cars on the road = 1.3 billion autos in the world toady. We project winning over about ⅓ of those to join this Membership program within a (half) decade = about 400 million Member Drivers.

We use a standard $50,000 pick-up truck for our example here. Let’s say it cost 25% to meet all replacement/ repaired costs over a decade (to fulfill our proposed 350,000-mile warranty or ⅓ the Million-Mile Warranty). That bill would come to $15,000 as the typical ‘normal’ cost of repairs at today’s prices.

Let’s also say the membership reduced this standard cost by 30% as outlined above (in our 3 Steps of Part 1 of the Formula). This would reduce the cost of today’s repairs from $15k down to just $10,000.

That $10k is divvied up over a decade of premiums = $1,000 a year. That is $80 a month. $40 (of that $80) would be covered by the insurance policy - premium side. The other $40 would be covered by the monthly warranty charge. There would be an additional co-pay of say $3,000 at the time of work - a final bonus/ profit margin for the repair service provider. Most of these repairs would be done incrementally over the decade so many repairs would average just $2,500 as the typical cost to the auto industry and lets also say they were staggered out into an average of about 3 years. This would be matched by the owner with an additional Co-pay of $900. Put simply, all very, very affordable pay-outs for both the auto-makers as well as the owner.

GM now collects on both this $40 as well as the insurance fee. We use a working figure of $145 a month insurance premium. This gives us a total of $185 (with Warranty fees added in) = $2,220 a year.

Let’s also say GM has 30 million trucks on the road today. This added income of $2,400 a year, per truck owner, generates GM an additional $122 billion a year. This would be on top their present $150 billion annual (sales) income. We just doubled their present revenues.

Extending our membership program (to 70% of GM’s other 150 million drivers) would further generate another $100 billion a year. Once combined, the membership looks to nearly tripled GM’s annual revenues. That comes to $800 more per year, per car = $66 per month. That $66 is divided between the insurance policy and the warranty = $33 each. A 15% cash co-pay would also be paid at the time of service.

GM is now getting $277 billion in annual revenues. Below, we show that we would then add auto financing for GM to collect. Combined, this offers GM a half trillion a year income compared to the $150 billion they generate today. This is a 4-fold boost in overall revenues. This is a lot more income for automakers and a much better service, with some big, big savings for owners.

### Part 4 of the Formula

### 30-Year Financing - Time Value of $ & Dynamic Pricing

The First factor for this added revenue is the combined advantages of 4 areas that work in conjunction with each other. There’s the rate of inflation. There’s the new, multiple streams of revenue and each of these offer pricing flexibility to raise premiums in step with rising costs. We refer to this as Dynamic Pricing. We will outline how Dynamic Pricing is the replacement -upgrade - to most all the pricing dysfunctions we find of the used car market - explained below.

Today’s retail sales model has little wiggle room to account for the host of cost spikes we beget of auto repair. The sale has a set, one-time, purchase price much like most warranties. This limits automakers from offering comprehensive warranties. Instead, all these expenses are left piling up on the back end - when the Used Car is brought in for repairs over the next decade. Automakers wash their hands of this bottleneck in costs escalations and leave it to third parties (auto-repair shops, dealers, etc.) to pick up with all manner of service and pricing exploits.

Dura-Tech reduces these repair cost (as outlined above) and then divvies up these expenses by spreading them out over 10 to 30 years of very affordable payments.

Let’s start with Inflation. America held a steady 3% inflation rate for much of the last 4 decades. That means a 6% rate of interest is double that cost of inflation. No matter the rate of inflation, our membership model provides the means to adjust both these costs and profits in step with this inflation factor. (6% gives us a working model to outline the program.)

Let’s take the example of our Insurance and Warranty premiums to see how that plays out with both inflation and the exponential returns of compound interest that rides upon price escalation and this new found access to rising premiums for auto-makers.

We take the annual $2,220 cost of Insurance & Warranty from our last chapter. Now multiply that at a rate of 6% a year over 30 years. That monthly premium hits about $10,000 by year 31. That is 4.5 x the original price of the annual premium 3 decades earlier. The Co-Pay jumps from $3,000 to about $11,000 over that same 3 decades. A 5% rate of price inflation still gives us 2.5 x the original price for the Warranty & Co-pay.

Put simply, these Warranty and Insurance services offer the mechanism to tap such pricing flexibility otherwise missing from today’s warranty services - and all the while offering the means to hold to a steady profit margin and still prove reasonable rates and great savings to customers. The value of these premiums is naturally multiplied with each decade that it is extended into, as it rides the rising tide of inflation. This pricing flexibility finally offers automakers the means for a truly comprehensive warranty that is affordable to them and customers alike. All the shortfalls of the used-car industry and their pricing bottlenecks and corresponding price gauging are sidestepped along with it - at long last.

### Multiple Steams of Revenue & Price Flexibility

These insurance / warranty and financing programs are the platform - means - to tap both long-term revenue streams as well as to generate such incomes above the rate of inflation (and other related costs). It’s the primary reason automakers need take over these areas of auto services of insurance, warranty and financing. It is the mechanism to tapping the monies to be mined from the used-car market as well as reform and the complete upgrade of it.

For example, warranty pricing can be raised while holding insurance steady and vice versa. Most warranties don’t coordinate with insurance policies and so limiting the versatility of both. Control of and coordination between these multiple venues of service and revenues allows far better management - efficiencies - between them and the customer experience. This will dramatically shift public perceptions for all brands using this service.

Most all warranty policies today are paid upfront by buyers. This leaves manufactures little flexibility for pricing adjustment without breaking the terms of contract. Therefore, manufacturers second guess their terms with all this fine print of exceptions to the warranty contract. Here is where we beget the genesis to all the rest of the dysfunctions of the used-car market. Today’s warranty is paid for a service that is going to be hit with rising costs they can’t predict - in a (half) decade from now, nor the means to raise additional funds. This Dura-Techs (Auto) Membership sides steps these restrains. Automakers are no longer locked into such pricing constraints. The Insurance and Warranty services allow them to raise premiums as needed - gradually, profitably -for the first time. Dynamic Pricing is critical to reforming the used car market, much as it is central to this Dura-Tech Membership formula. As such, taking over Insurance and Warranty programs is a must for the automakers wanting to tap the greatest potential of their products great prospective treasures. This is the basic function Dura-Tech plugs into for automakers to access - a simple means to consolidate all these other players, cost efficiencies and upgrades into a very manageable coordination under their supervision - topped with pricing flexibility throughout the auto’s entire life span.

### Affordability Compounded by Decade - Staggering

The flexible and higher premiums we beget of Insurance and Warranty are divvied up into affordable monthlies. The costs is further reduced in each decade added. Example 1) The repairs of the previous decade will regularly translate into added durability the following decade. We refer to this as Staggering. We gather that this will become a primary component of both our Membership program and those of industry design and planning in general.

We may find that the 3rd decade, for example, would regularly have less repairs than those of the 2nd decade when it comes to a vehicle like Tesla’s Cyber Truck. Let’s say Tesla’s million-mile batter has some problem in year 18. Replacing the battery at that time should allow it to last until the end of the 30-year term. Same again for their electric engine, etc. Longer the warranty & financing term, lower the overall costs and premiums through this process of overlapping lifespans of the different replaced parts. We gather that in time, this will develop into its own schedule of Staggered replacements and up-grades. This will all be added in and between the ‘free’ replacements and those with Co-pays.

Example 2) is with (the leading EV manufacturers) Tesla’s battery - again. As production continues to rise, lower its costs will become. We have already seen how batteries continue to fall and are on track to fall at a faster rate still. The battery technology of 2035 will LIKELY have significantly lower cost points - much like the electric engine. The longer-term warranties allow automakers to tap these kinds of improvements and all the while, still collect income today for the lower costs of tomorrow. There are other examples of these price savings and other advantages compounding over the decades.

### Better Profits Multiplied by the Time-Value of Money & Consolidation

In today’s retail model, automakers make most money up-front with the sale of the auto. They do try and squeeze some additional income from the Used Car owner after that initial purchase. The Used Car market does indeed represent 30% of the entire industry, but how much of that actually goes back to the automaker? Most goes to the ‘Third Parties’ we talked of in earlier chapters. They are the ones making most of the ‘profit’ from this market, not automakers.

Let’s say 10% of today’s total Used Car Market makes its way back to the automaker. Our membership program is doubling / tripling those revenues in large part via this Warranty. Remember, the warranties $80 a month of our example above are the small payments from that large $10k budget calculated to meet all repairs. (And that $10k represented just 75% of today’s total cost for repairs - after cost savings). Adding in the insurance premium offers another 180% = $145 a month, on top the warranty income.

Now add in the rising cost of inflation to the $2,220 a year revenue. That grows and combines into $150,000 by year 31.

In short, the first two big advantages is harnessing the Time Value of Money via interest and inflation to layer on long term revenues and their guaranteed profit margins. That total income combines into $100,000 / $150k - per $40k car. Again, this is all possible by that magic fairy dust of the 30-year term.

### Profit of 5 Autos in Sale of 1

A 25% profit on the $150k represents $30k return on repairs. Compare this to the cost of today’s repairs at $15k. Most of that cost now goes to repair shops. How much of that actually makes it way back to the automaker? 10%? That would be $1,500. Under Dura-Tech, the $30k goes directly to the automaker. Would this offer a 50% profit margin? That would be 10 x the return for automakers then what they can skim from today’s used market system.

Put another way, the automaker is making the profit margin that would only otherwise be possible by selling 2 to 4 additional new cars. This membership program reduces this production demand by simple repairing that 1 auto with our EXTENDED warranty.

GM averages a 7% profit margin. That means the $25k car is bringing in $2k of profit. Let’s also say they make another $1,500 off repairs for a total profit of $5k per car. This means the Dura-Tech membership will provide the equivalent profits for 5 of today’s $25k cars against just one of our autos now covered by the warranty. Dropping the number of cars from up to 5, down to just 1 is an 80% reduction in labor and materials saved from those 4 cars that no longer need be produced. The amount of time, effort, investment and headache from these reduced manufacturing and marketing costs should be properly calculated to better measure the incredible saving this approach offers auto-makers. This alone provides a great deal of cost savings and corresponding opportunities for additional profits.

This resizes production so it’s more profitable to repair 1 car rather than having to produce 2 to 5 new ones. This is due in part to the improved Dura-Tech; however, the majority of this gain is found by changing out from today’s retail model and switching over into this 30-year membership program. The longer-term financing allows all the different moving parts with the extra-time necessary to maximize their advantages both individually and especially combined whether that be found in the Staggering, Dynamic Pricing or the Time Value of Money. We see this with the (leading EV manufacturer and their stainless steel truck) Cyber Truck. (This EV company) Elon Musk has provided all these tech up-grades and durabililty, but its only in our 30-year Financing & Warranty programs that this added 5 fold income can be properly tapped to its fullest (by Elong Musk).

Automakers are no longer bullied into having to sell a new batch of cars every year to remain financially solvent. This Dura Tech Membership makes it so much easier to just repair part of an old car instead of making 3 to 5 new one - and then having to sell it again to that same buyer every (few) decade(s). All these advantages are tapped once financing is combined and extended out into that ‘Magic Formula’ of 30-Financing & Warranty.

### Insurance Cash Holdings + Auto Financing = 50% Profit

Running the Insurance side also hands automakers cash holdings -lots of cash. They get to hold these funds for a (half) decade before they have to pay it out for repairs.

### Capital Pool

(The CEO of the leading EV company) Elon Musk stumbled upon this component of the insurance business and began to recognize the value a capital pool of insurance offers its company. (The CEO) Elon Musk was annoyed at the higher insurance premiums that 3^{rd} party companies were charging his Telsa drivers. After reviewing the industry, (the CEO) he calculated that insurance would come to represent a whopping 40% of his (company’s) entire business. Born of this is talk that (this CEO) Elon is now looking at all the value found in employing this Capital Pool rather than handing it over to the insurance industry to play with. Of course, he would use it to finance Tesla autos. This has the effect of compounding profits wherein the insurance offers its own set of profit margins while that Capital Pool is used to finance autos with their additional profit margins. This being one of several scenarios to the advantages to be tapped from holding the capital from the insurance and warranty side of the industry - this formula. The Capital Pool is likely to prove far more profitable - advantageous- then outlined here.

Here’s some working numbers for a ‘rough idea’ how this may playout. Using this insurance cash - Capital Pool, to finance their own vehicle sales offers the perfect investment. Let’s say the interest rate for a new car is 6%. This would be one of the best market rates available to investors today. (They can charge this kind of fee because it’s part of the ‘all or nothing package’ deal of the Dura-Tech Membership. This would be on top the built-in profit margins of the car. Let’s peg that profit to say 20%. This 20% margin plus the 6% rate of interest/inflation gives manufacturers a 26% rate of return - before inflation. Remember, all these programs are housed under one roof - Service Platform, This in turn allows them to build in stronger profit margins as well (as this leading EV company Elon has demonstrated).

These profits from auto’s would be on top the additional 6% inflation /interest rate made on the insurance / warranty. And remember, insurance and warranty are also making a profit. Let’s peg their average profit margins at 15%. Taken together, they are looking at a 21% profit.

Combine the 26% profit from the auto + financing and add the 21% profits from the insurance and warranty + interest. This hands automakers a combined profit of 47%. Now we are beginning to see the compounding magic to the time value of money multiplied by the consolidation of industries and services as a single service platform. And there sits this Capital Pool to finance it all. This is simply a cut and paste of (this EV’s CEO’s) Elon’s insurance and other programs in the works over at (this EV company) Tesla.

Yes, these are working figures here, but they demonstrate the kinds of multiplier found in offering insurance, warranty and financing alongside this 30-year loan program.

Once combined, we are looking at 5 to 7 x more in profit then we see of today’s retail sales program and their short 5-year financing. Taking the example of that $50k pick-up truck given earlier gives us a total of $150k by year 30. We then have another $140k from Insurance, Warranty & Co-pay.

The punchline is that the $50k pick-up truck will generate about $300k by year 31, once you have included financing, insurance, warranty premiums. (Again, ‘working numbers.’) These kinds of multiples are the expanded returns (this EV CEO) Elon Musk can gain by simply introducing this last step of our 30-year financing term and its Million-Mile Warranty of this Dura-Tech Membership program. The Cyber Truck is the perfect vehicle to start with because of its stainless steel body and electric engine.

### Longer the Term, More Affordable Larger Margins

Today’s automakers have a hard time squeezing out a 20% profit margin from most any of their auto lines and same again in trying to get a 6% interest rate on their auto loans. Extending the loan term to 30 years drops the monthly premiums so drastically as to makes such added margins easier for the buyer to afford. Compressing all payments into just a half decade leaves the monthlies so much more difficult for increasing number of buyers to meet. The longer 10, 15 and 30 year loan terms will proportionately allow ever larger margins per each decade added while still proving far more affordable over today’s monthly premiums

### 70% Monthly Reduction = 70% Price Auto

Today’s $25k auto costs about $300 a month. The 30-year loan buys you the $70k vehicle for that same $300 a month. In other words, the lower prices of the 30-year mortgage will simply have more buyers purchasing the more expensive line of autos. A 70% drop in the monthly premiums means buyers will now be buying an auto that is 70% more expensive than what they can otherwise afford in today’s 5-year loan program.

The 30-year loan means that today’s luxury brands are going to be the new standard of the mass market. It will be the new normal. It’s a giant step up the ladder of luxury for the mass market buyer. For manufacturers, the 30-year financing buys them up to 7 x more revenue off the same auto, but now that auto is also 3 x more expensive. For example, instead of selling their $25,000 model to the mass market, they will be selling their $70,000 model to that same mass market. The multiplier will be in both income as well as the higher price point.

Most autos today simply cannot last that million-miles and so will not tap all these advantages of the 30-year loan. (The leading EV’s pick-up truck) Tesla’s Cyber Truck has all the requisite elements to qualify and ready to convert over to this 30 year model - immediately. That also means (that this EV pick-truck) Tesla will be selling (their) Tesla’s top $70k brand to the mass market. Those that can only afford an auto priced at $25k today will now be able to afford the $70k (EV pick-up) Cyber Truck.

### More Financing Options With Appreciating Asset

There is a knee jerk reaction and reservation some people have to the idea of 30 year ownership. In part, such critics are right. Many buyers will still be changing out into the newest auto after just 10 years. The difference will now be on the Used Car market side. This is where the Dura-Tech Membership comes into play with all its advantages for the used car buyer.

The added longevity of the Used Car means it holds its value longer and so presents a greater number of refinancing opportunities.

Today’s used car market basically has two main purchases. There’s the original used owner and then a 2nd owner 3 to 7 years later. This is most common for the Auto-Lease market. The used car buyer keeps the auto another 5 years or so before they are forced to buy another used car or spend on the punishing repair costs to fix it.

In the case of the auto with its 30-year warranty, that original buyer will have a large down payment, but thereafter, there can be regular - small - down payments. For example, the first buyer may pay $3,500 down. 5 years later, another down payment - like lease to own, of say $2,500. There can be these successive down payments every 5 years or so. Dura-Tech can get in 6 such down payments as compared to the 2 we have with today’s lease and retail sales model. This will do wonders in lowering monthly premiums while serving to help regulate effective maintenance and ownership. Basically, we can have 6 sets of lease-to-own terms compared to just the two term cycles we have in today’s market.

### 30 Years = Classic Car

We will see a lot more refinancing of these auto’s with the million-mile warranty because they will have crossed over into home mortgage territory. They become an appreciating asset rather than the depreciating auto that we have today. The Dura-Tech Auto Membership will build upon, duplicate and scale the ‘classic car’ market by providing a novel auto in mint condition - 30 years later, due to its great warranty. In other words, the classic car is an auto that is worth as much or more by year 31 then when it was first bought 3 decades earlier. We could very well call our 30 Year Membership program the Classic Car Program.

This means we will see an explosion of refinancing options during this 30-year warranty more comparable to the constant refi we see of home mortgages - complete with 2^{nd} mortgages as well. This of course lends itself to a whole other layer of profits & prospects - to be reviewed later. We will see a large expansion of down payments and other such refinancing terms.

### True Membership Program

Divvying up all these repair & insurance cost and then spreading them out over a decade leaves us with a true, affordable membership program. Advantages listed in Tesla Report.

### Dura-Tech Profits Cover Loss of Trade-ins

The added profits of the 30-year term may prove enough to absorb the loss of upgrading legacy makers present drivers into a new, higher luxury brand, with the durability of a million-mile warranty. If GM could convert say 70% (or even 35%) of the drivers of their present autos over into a million-mile luxury vehicle, it would prove a stunning marketing program. GM would hit a half trillion a year income. 20x revenue means they are now a $2 trillion (?) company.

### Part 5 of the Formula

### Membership Program

The Dura-Tech Auto Membership consolidates all of these programs into a single package. It’s easier to sell the entire package compared to the confusion of today’s long list of varying services & benefits against their accompanying fine print. Each of these Dura-Tech programs do offer each individual service as a stand lone program, but then, they will come at a higher premium then the bulk rate price given with the package deal. People may not want to pay the 6% interest on the auto financing, for example, but then they may have to pay $135 vs $40 for the Warranty and a higher Co-pay too.

The Tesla Report outlines a number of the big advantages to be gained from a membership-based program over today’s retail model. The bottom line is that this entire campaign is geared to convert buyers into Auto-Members. Today’s sales model offers a warranty to sell the car. Dura-Tech offers the car to sell the Membership. Our ‘working numbers’ suggest that our Dura-Tech Membership program could boost revenues 3 to 7-fold over those that auto-manufacturers make today. Such is the way of a reinvented marketing & service Platform.

Upgrades offer another boost of revenues alongside the marketing punch they can deliver. ‘Members’ can get any number of products and services as both a benefit and of course, as a cross promotional with free or ‘give-away’ prices on a host of breaking trends. Again, (the aforementioned EV CEO) Elon Musk has led the way in his relentless re-engineering of the everyday products such as sound systems, VAC (heating & Cooling systems), security systems and of course, software. While Tesla has 1 million new autos for their new VAC system, the legacy automakers have 1.3 billion autos that can be outfitted with their latest and greatest product line. Same again with the latest sound system or security system. They can be offered at stunningly low prices as a membership benefit. It’s amusing to hear the raving reviews of Tesla’s ‘real time’ feed from billions of miles of AI video feeds coming in from their millions of drivers. Legacy manufacturers can far surpass this rather easily by simply installing similar camera systems on any number of the 1.3 billion drivers of their cars today. It’s a video camera tied to a data port. No reason this can’t be installed on 400 million other cars on the roads today. 400 million members is a fairly massive marketing platform for legacy automakers to partner other products for - at stunningly affordable prices.

In summary, the Dura-Tech Membership program finds its added income for auto makers via the power in the Time-Value-of-Money, a multiple of new revenue sources and the replacement to a cross section of other industry players while buyers find the bulk of their savings in the extended timeline and the removal of expensive 3^{rd} Party players and the cost efficiencies gained from removing all the price gauging - fraud.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A method for providing automotive warranties and financing, the method comprising the steps of:
consolidating the used car industry by performing the following: replacing the third-party players, reducing the cost of parts and labor, managing insurance providers, and controlling pricing and labor, and bringing new revenue streams on line for auto manufacturers for the first time;
providing warranties and co-pays;
segregating the cost over a period of time, wherein the period of time runs between 10 to forty with the thirty year financing terms standing as the ideal; and
providing a membership program as an all purpose, Service Platform.
